(19) United States
(12) Patent Application Publication
(10) Pub. No.: US 2006/0150810 A1
(43) Pub. Date: Jul. 13, 2006

(54) Gas cleaning devices

(76) Inventor: Peter Kukla, Manchester (GB)

Correspondence Address: MICHAEL BEST & FRIEDRICH, LLP, 100 E WISCONSIN AVENUE, MILWAUKEE, WI, 53202, US

(21) Appl. No.: 10/528,616

(22) PCT Filed: Sep. 22, 2003
(86) PCT No.: PCT/GB03/04164

§ 371 Date: Mar. 21, 2005

(30) Foreign Application Priority Data
Sep. 21, 2002 (GB) 0221989.7

(51) Int. Cl. B01D 53/22

(52) U.S. Cl. 95/55

(57) ABSTRACT

There is disclosed a gas cleaning device (4) comprising a gas inlet (6), a gas outlet (8) and a path of fluid communication (10) between the gas inlet and gas outlet, a filter (14) in the path of fluid communication and ionising means (16), which ionising means is at least partly within the filter. A vehicle (3) incorporating such a gas cleaning device in the exhaust gas flow path of an exhaust (2) thereof is also disclosed.

### FIELD OF THE INVENTION

The present invention relates to gas cleaning devices and to vehicles incorporating the same.

### BACKGROUND TO THE INVENTION

An internal combustion engine generates a wide range of pollutants in use. Carbon based pollutants are an especial problem in that their particulate size is such as to cause serious health concerns. Many attempts have been made to reduce the level of pollutants in an exhaust gas stream, concentrating on cleaner burns and the use of catalytic converters. However, it is still desirable to reduce the pollutant levels further and in many countries legislation is being considered that will require, or at least make more beneficial, a reduction in pollutant output.

It has been proposed to provide pollutant removing devices in vehicle exhausts. Where this is done, and generally on a vehicle, it is preferred that the size of the relevant device be kept to a minimum.

Preferred embodiments of the present invention aim to overcome or obviate a problem associated with the prior art, whether referred to herein or otherwise.

### SUMMARY OF THE INVENTION

According to the present invention in a first aspect there is provided a gas cleaning device comprising a gas inlet, a gas outlet and a path of fluid communication between the gas inlet and gas outlet, a filter in the path of fluid communication and ionising means, which ionising means is at least partly within the filter.

By providing the ionising means at least partly within the filter there is a substantial space saving.

Suitably, the ionising means is partly within and partly outside the filter. Suitably, the major part of the ionising means is within the filter.

Suitably, the ionising means is mounted externally of the filter. Suitably, the ionising means comprises a first end and a second end is mounted at the first end only.

Suitably, the filter comprises a hollow tube into which the ionising means projects.

Suitably, the ionising means comprises an electrode.

Suitably, the electrode comprises an elongate filament.

Suitably, the filter comprises a filter opening the leading edge of which is returned.

Suitably, the device further comprises an exit tube at least partly in the filter. Suitably, the entrance to the exit tube comprises an external truncated cone.

Suitably, the path of fluid communication comprises a first path through the filter and a second path avoiding the filter. Suitably, the second path is through the exit tube opening.

Suitably, a return hole is provided in the exit tube for the first flow path to join the second flow path.

Suitably, the hole is small relative to the cross-sectional area of the exit tube.

Suitably, the filter comprises an electrically conductive layer adjacent a filtration layer. Suitably, the conductive layer is to the interior of the filtration layer. Suitably, the conductive layer comprises a gas permeable layer. Suitably, the conductive layer comprises a metallic layer. Suitably, the conductive layer is connected to a power supply, whereby the conductive layer can be electrically heated. Suitably, the conductive layer is at least partly coated in a less conductive layer.

According to the present invention in a second aspect, there is provided a vehicle comprising a vehicle exhaust with an exhaust gas flow path and a gas cleaning device according to the first aspect of the invention in the exhaust gas flow path.

### BRIEF DESCRIPTION OF THE DRAWINGS

The present invention will now be described, by way of example only, with reference to the drawings that follow; in which:

FIG. 1 is a schematic perspective illustration of a vehicle exhaust incorporating a gas cleaning device according to the present invention.

FIG. 2 is a cross-sectional elevation of a gas cleaning device according to the present invention in a first aspect.

FIG. 3 is an enlarged view of part of FIG. 2 showing the filter opening.

FIG. 4 is a cross-sectional elevation of a gas cleaning device according to the present invention in a second aspect.

FIG. 5 is an enlarged cross-sectional elevation of an electrode mounting arrangement suitable for use with the present invention.

### DESCRIPTION OF THE PREFERRED EMBODIMENTS

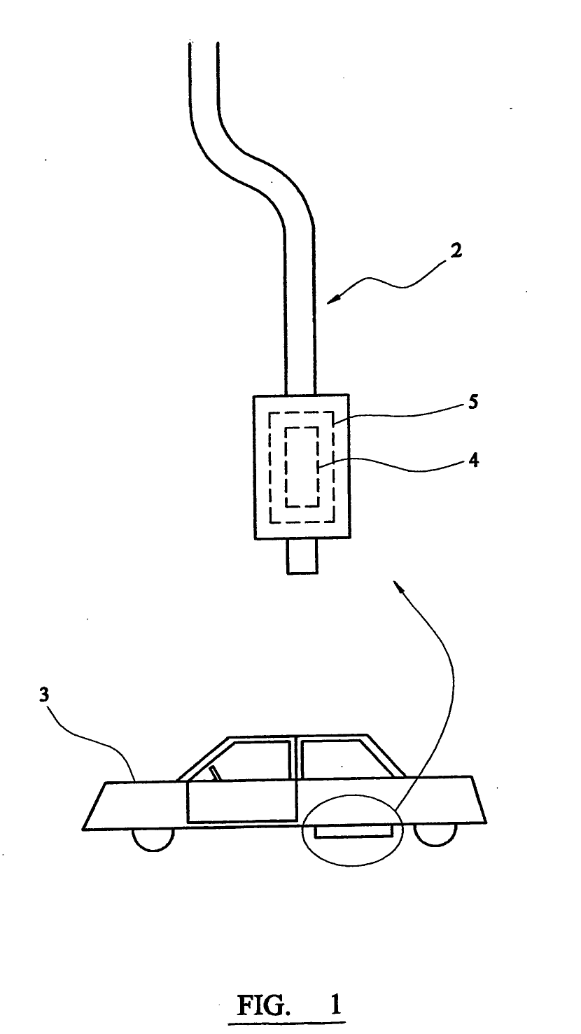

Referring to FIG. 1 of the drawings that follow, there is shown a vehicle exhaust 2 of a vehicle 3 for use, typically with an internal combustion engine fuelled by diesel or petrol (gasoline). The exhaust 2 incorporates a silencer 5. Incorporated in the exhaust gas flow path of the vehicle exhaust is a gas cleaning device 4 according to the present invention. The gas cleaning device 4 is located in the silencer 5.

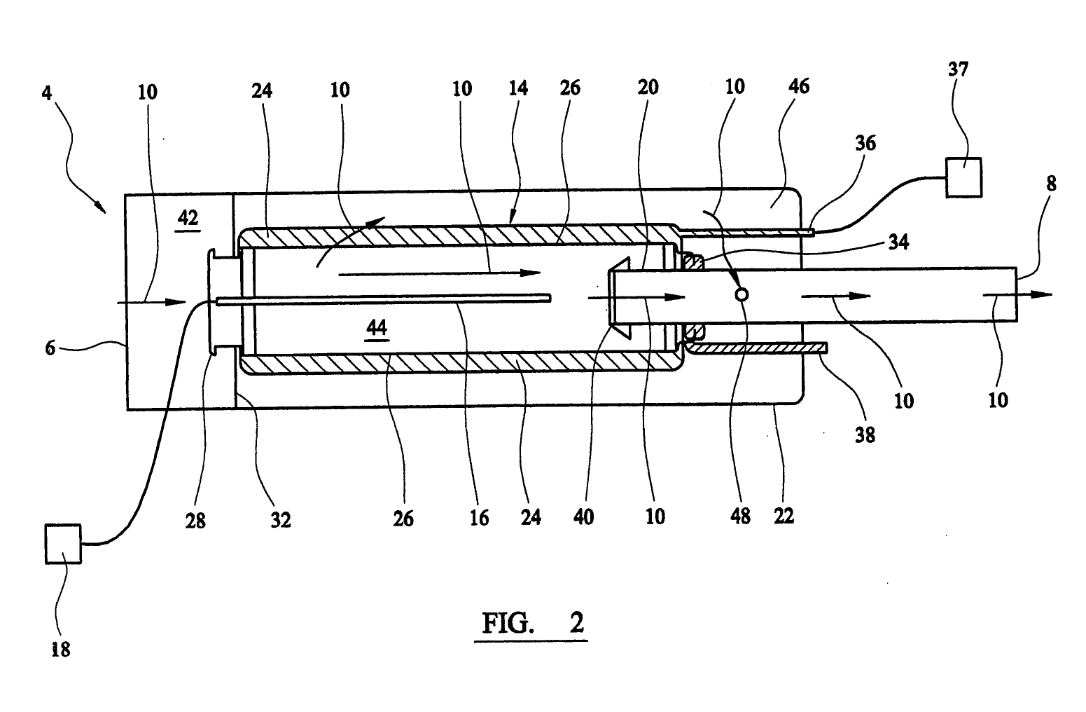

Referring now to FIG. 2 of the drawings that follow, the gas cleaning device 4 comprises a gas inlet 6, a gas outlet 8 and a path of fluid communication indicated generally by arrows 10 between the inlet 6 and outlet 8. The path of fluid communication 10 provides a gas flow path between the inlet 6 and outlet 8.

In the gas flow path is a hollow, circular, cylindrical, tubular filter element 14. Extending into the filter element 14 along the longitudinal axis thereof is an electrode 16 connected to a high tension power supply indicated schematically at 18. Also partly in the filter element 14 is a gas exit tube 20 leading to outlet 8.

The filter element 14 and other components are mounted within and supported by a housing 22.

Filter element 14 comprises a circular cylindrical hollow tube of gas permeable filter material 24 for removing (at least partly) a pollutant from a gas flow therethrough. A suitable filter material is NEXTEL (trade mark) available from 3M. The interior exposed face of the filter material 24 comprises a gas permeable electrically conductive metal layer 26 comprising a plurality of holes therethrough substantially to permit the free flow of gas and particulates. The metal layer 26 is coated with a coating of lesser conductivity (relative to the metal layer), as is that inner part of exit tube 20 that projects into filter element 14. The lesser conductivity coating is an organic coating, which acts as a resistive barrier coating. A suitable coating is TLHB/02 available from Camcoat Performance Coatings of 127 High Street, Bewsey Industrial Estate, Warrington WA5 5LR, United Kingdom.

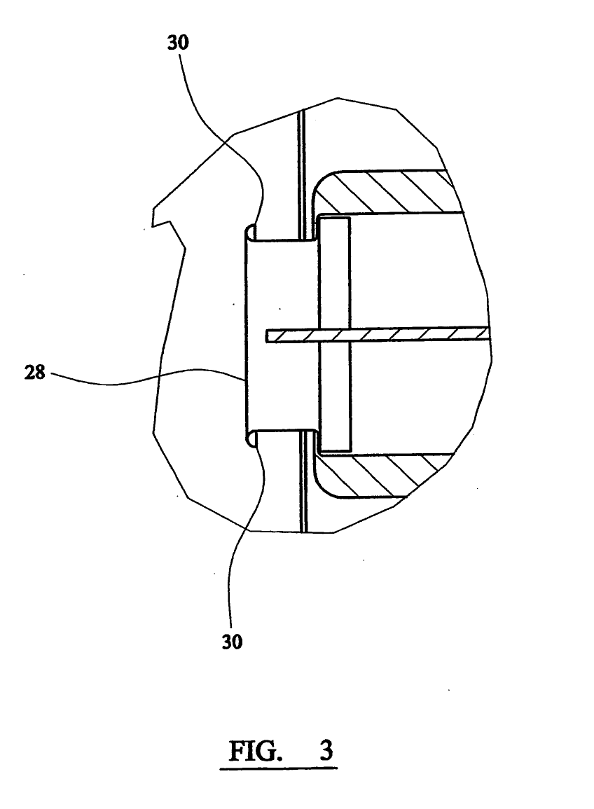

At the electrode end of the filter element 14 the metal layer 26 terminates in a filter opening 28 with returned edges 30, more visible in FIG. 3. Housing 22 includes a gas impermeable wall 32 in which filter opening 28 is secured. At the exit end of the filter element 14 the metal layer 26 terminates in an insulating collar 34 formed from a ceramic material.

Extending from filter element 14 through housing 22 is an electrical contact 36 and a thermocouple 38. The electrical contact 36 is connected to a 12 volt (eg vehicle battery) power supply 37 for the periodic heating of the metal layer 26 to burn off accumulated particulates from filter material 24. Thermocouple 38 can be used for monitoring the exhaust gas temperature.

Exit tube 20 is generally circular cylindrical and hollow, mounted along the longitudinal axis of the filter element 14, so the electrode 16 and exit tube 20 are substantially aligned. Exit tube 20 has a truncated conical opening 40. Exit tube 20 extends through housing 22 to gas outlet 8.

A mode of operation of the FIG. 2 embodiment of the present invention will now be described. For the purpose of this explanation it is convenient to divide the device 4 into three separate chambers, which are an inlet chamber 42, an in-filter chamber 44 and a post-filter chamber 46. Inlet chamber 42 is prior to the entry of gas flow into the filter 14. In-filter chamber 44 is the volume within the filter 14. Post-filter chamber 46 is the annular volume about the filter 14 and at its end that is outside gas exit tube 20.

In use the electrode 16 is maintained at a relatively high direct current voltage, typically 35 kV. As the device 4 is in the vehicle exhaust gas stream, exhaust gases enter the device 4 through gas inlet 6 into inlet chamber 42 from which their only exit is through the filter opening 28 into filter 14. During the time the exhaust gases spend in inlet chamber 42 and at the upstream end of filter 14 the gases and accompanying particulates are in the vicinity of the charged electrode 16 which acts as an ionising means to ionise a significant proportion of the particulates in the gas flow stream. The ionised particulates are attracted to the metal layer 26 on the interior of the filter element 14. Combined with the existing downstream momentum of the particulates, this means that they tend to flow towards the metal layer 26 and along the filter element 14. With the momentum the particulates have, and to some extent carried along by the general downstream gaseous flow, particulates pass the metal layer 26, through the plurality of holes therethrough, and pass into the filter material 24 of the filter element 14 where they are trapped and cleaned from the gas stream. Thus, gas passing through the filter element 14 has particulate pollutants removed therefrom, at least in part.

The other exit from in-filter chamber 44 is through gas exit tube 20. Gas can flow freely into the gas exit tube 20 but the gas that does so from in-filter chamber 44 tends to have a highly reduced particulate concentration because a significant proportion of them have been ionised and attracted away from the central gas flow stream that passes into gas exit tube 20.

The gas that passes through filter 14 enters post filter chamber 46 about the filter element 14 and can re-enter the gas flow stream to outlet by a hole 48 in gas exit tube 20.

Thus, there is a first gas flow path from inlet 6, to inlet chamber 42, into in filter chamber 44, through filter 14 to post filter chamber 46, into gas exit tube 20 through hole 48 to outlet 8. A second gas flow path is provided from inlet 6, to inlet chamber 42, into filter chamber 44, then to gas exit tube 20 to outlet 8, which second gas flow path does not pass through and avoids filter 14. This helps avoid the build up of undue back pressure.

The organic coating seems to prevent the charged particulates from discharging on contact with the metal layer 26. If they did so they could drift back into the main gas flow stream and not be filtered.

It is believed that this device is beneficial in the removal of carbon particulate pollutants from an exhaust gas stream.

The returned flange 30 of the filter opening 28 ensure that something intervenes between electrode 16 and the free end of the filter opening 28 to avoid arcing to the charge concentration at said free end.

The truncated cone 40 at the entrance to gas exit tube 20 acts to deflect mid-stream particulates to the filter element 14 and avoids a free end being presented to electrode 16, again to avoid arcing.

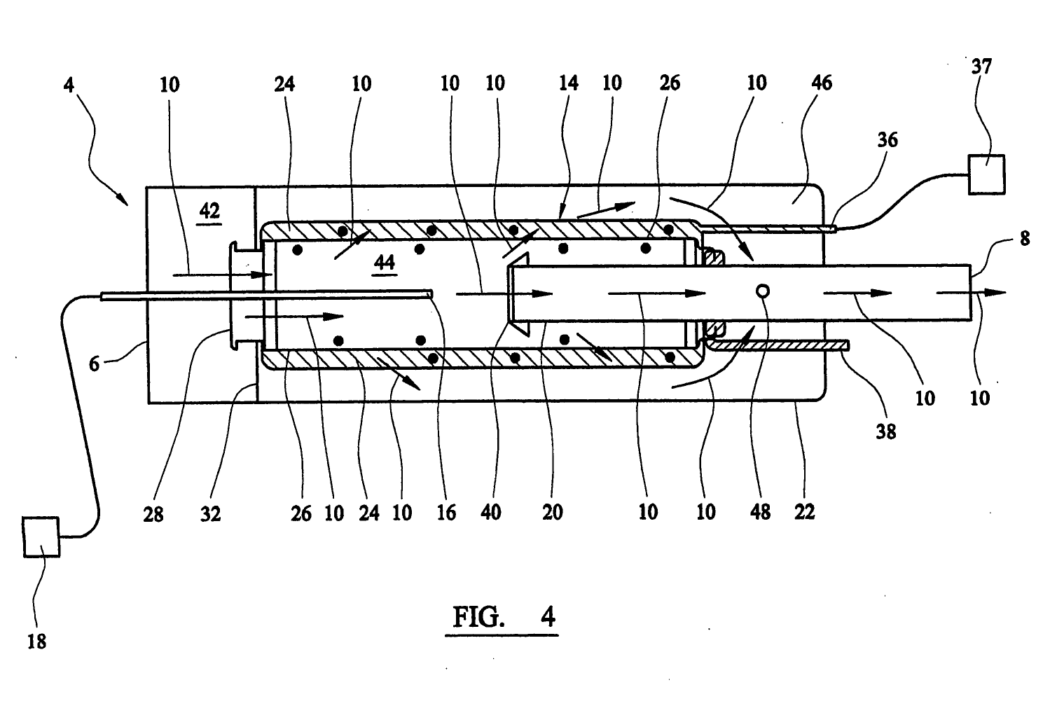

Referring to FIG. 4 of the drawings that follow, the device 4 is substantially similar to that shown in FIG. 2 except that the electrode 16 and gas exit tube 20 are positioned in a longitudinally different configuration.

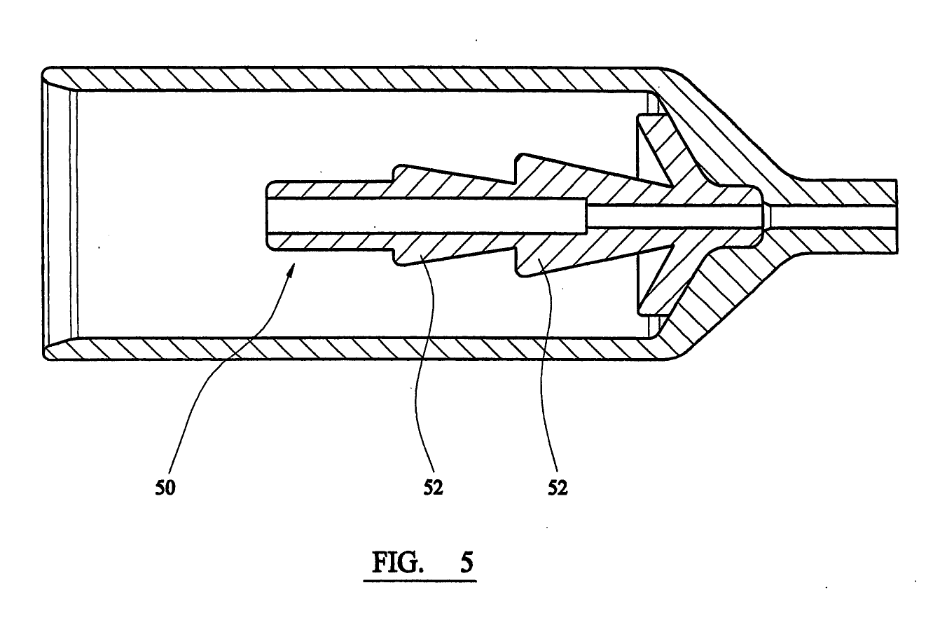

Referring to FIG. 5 of the drawings that follow, there is shown an electrode mounting arrangement suitable for both the above described embodiments of the present invention. A ceramic electrode mount 50 carries electrode 16 centrally therein. The electrode mount 50 comprising a plurality of protrusions 52 along its length to minimise the risk of shorting out. The electrode 16 is mounted at one end thereof only.

In use one or more of the devices shown can be used in series or parallel. The overall size of the unit can be scaled to suit the application. It will be appreciated that although described for use in relation to a vehicle exhaust application, the device may be of use in many gas cleaning applications. Devices according to the present invention need not remove all pollutants nor all or any one pollutant. Some pollutant concentrations may, indeed, remain unchanged.

Many minor variations to the components and their relative positions can be made. For instance, the position of the gas exit tube cone 40 can vary along the interior of the filter element 14; the distance between the electrode 16 and the gas exit tube 20 may vary; the diameter and size of the filter 14 can vary in relation to the gas exit tube cone 40 size and position, the gas exit tube cone 40 angle of deflection, aperture and spread can vary; the gas exit tube 20 can vary in length and diameter; the gas re-entry hole 48 can vary in size and shape, and there may be several such gas re-entry holes provided; filter material 24 may vary in thickness and type; the filter opening 28 diameter may be equal to, greater than or smaller than the filter diameter.

By providing the filter 14 about the electrode 16 rather than downstream thereof as a separate unit, the size of the device is much reduced.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A gas cleaning device comprising a gas inlet, a gas outlet and a path of fluid communication between the gas inlet and gas outlet, a filter in the path of fluid communication and ionising means, which ionising means is at least partly within the filter.

2. A gas cleaning device according to claim 1, in which the ionising means is partly within and partly outside the filter.

3. A gas cleaning device according to claim 2, in which the major part of the ionising means is within the filter.

4. A gas cleaning device according to claim 2, in which the ionizing means is mounted externally of the filter.

5. A gas cleaning device according to claim 4, in which the ionising means comprises a first end and a second end is mounted at the first end only.

6. A gas cleaning device according to claim 1, in which the filter comprises a hollow tube into which the ionising means projects.

7. A gas cleaning device according to claim 1, in which the ionising means comprises an electrode.

8. A gas cleaning device according to claim 7, in which the electrode comprises an elongate filament.

9. A gas cleaning device according to claim 1, in which the filter comprises a filter opening the leading edge of which is returned.

10. A gas cleaning device according to claim 1, in which the device further comprises an exit tube at least partly in the filter.

11. A gas cleaning device according to claim 10, in which the entrance to the exit tube comprises an external truncated cone.

12. A gas cleaning device according to claim 1, in which the path of fluid communication comprises a first path through the filter and a second path avoiding the filter.

13. A gas cleaning device according to claim 12, in which the device further comprises an exit tube at least partly in the filter and having an opening, and in which the second path is through the exit tube opening.

14. A gas cleaning device according to claim 13, in which a return hole is provided in the exit tube for the first flow path to join the second flow path.

15. A gas cleaning device according to claim 15, in which the hole is small relative to the cross-sectional area of the exit tube.

16. A gas cleaning device according to claim 1, in which the filter comprises an electrically conductive layer adjacent a filtration layer.

17. A gas cleaning device according to claim 16, in which the conductive layer is to the interior of the filtration layer.

18. A gas cleaning device according to claim 16, in which the conductive layer comprises a gas permeable layer.

19. A gas cleaning device according to claim 16, in which the conductive layer comprises a metallic layer.

20. A gas cleaning device according to claim 16, in which the conductive layer is connected to a power supply, whereby the conductive layer can be electrically heated.

21. A gas cleaning device according to claim 16, in which the conductive layer is at least partly coated in a less conductive layer.

22. A vehicle comprising a vehicle exhaust with an exhaust gas flow path and a gas cleaning device in the exhaust gas flow path, the gas cleaning device including a gas inlet, a gas outlet and a path of fluid communication between the gas inlet and gas outlet, a filter in the path of fluid communication and ionising means, which ionising means is at least partly within the filter.
